(19) United States
(12) Patent Application Publication
(10) Pub. No.: US 2014/0065880 A1
(43) Pub. Date: Mar. 6, 2014

(54) INTERCHANGEABLE MAGNETIC SWITCH SHIELD CONNECTOR

(71) Applicant: Remy Technologies, LLC, Pendleton, IN (US)

(72) Inventors: Micah Jones, Warren, IN (US); David Lee Durant, Anderson, IN (US); Dale Baldauf, Fishers, IN (US)

(21) Appl. No.: 14/017,589

(22) Filed: Sep. 4, 2013

Related U.S. Application Data
(60) Provisional application No. 61/696,652, filed on Sep. 4, 2012.

(51) Int. Cl. H01H 36/00; H01H 11/00

(52) U.S. Cl. CPC H01H 36/0006; H01H 11/005
USPC 439/607.01; 29/622

(57) ABSTRACT

The present invention provides a component such as an IMS that can quickly and easily be connected to a wide variety of different plug-type connectors. A modular system is taught in which a shield of the IMS is provided as an interchangeable part. Each different shield in this system is adapted to directly connect to a specific unique plug or harness of a target vehicle. Since the shields are all easily interchangeable, a wide variety of unique electrical connectors can be provided without the expense and engineering of the original component that would otherwise be required.

### BACKGROUND OF THE INVENTION

The present invention relates to the art of motor vehicle starters and associated components.

Vehicle starter motors are typically provided with a pinion gear and a solenoid. A shift lever operatively connects the solenoid to the drive assembly. The solenoid typically includes a solenoid coil that is linked to a solenoid plunger. The plunger is linked to the pinion gear though a shift lever. When the solenoid coil is energized, the solenoid plunger extends, thereby pivoting the shift lever. The shift lever urges the pinion gear into operative engagement with a flywheel member provided in a vehicle engine.

In certain heavy duty applications, the current supplied to the solenoid can be very high, ranging from 200 amps to 400 amps, depending on the particular starter motor and engine. This amount of current is much greater than the 4-6 amps that common ignition switches are capable of reliably handling. Therefore, many starter systems employ a separate integral magnetic switch (IMS). The IMS limits current draw of the starter motor to lower levels, e.g., in the range of 1-4 amps. When the IMS is activated, a pull-in coil in the solenoid is connected to a vehicle battery. Current then flows to the starter motor allowing the pinion gear to rotate and engage the flywheel. The IMS can be mounted directly to the solenoid or starter motor.

An IMS typically has four terminal connections, to the ignition switch, to ground, and to the battery and switch terminals of the solenoid. These terminals are usually connected by means of conventional terminal screws and, e.g., spade-type terminal leads, and this type of connection is still prevalent in the industry. However, the trend is toward replacing traditional terminal connectors with plug-in type connections or harnesses because this allows components, e.g., vehicle starters, to be installed more efficiently and with less likelihood of user error. For example, since each plug-type connector can have a unique geometry, it will only be possible for the installer to connect the plug to the correct corresponding connector and only in the correct orientation. Further, connecting by plug-type connections is quicker than connecting by traditional wire terminals. As such, multiple electrical connections are made quickly while minimizing the likelihood of error by the installer.

One drawback, however, is that there are no industry standards for these electrical connections amongst the multitude of vehicle and part manufacturers. Therefore, providing a “universal” connection for, e.g., an IMS to connect to the multitude of differently configured plug and play type of connectors that are envisioned presents design challenges. A solution is therefore needed which will provide a part such as an IMS that can quickly and easily be connected to a wide variety of different plug-type connectors without needing to redesign the IMS for each specific application.

### SUMMARY

The present invention provides a component such as an IMS that can quickly and easily be connected to a wide variety of unique plug-type connectors. A modular system is taught in which a shield of the IMS is provided as an interchangeable part. Each different shield in this system is adapted to directly connect to a specific unique plug or harness of a target vehicle. Since the shields are all easily interchangeable on the IMS, a wide variety of specific electrical connectors can be provided without the expense and engineering that would otherwise be required to provide a specific IMS for each particular application.

In one form, these teachings provide an electrical component for use with a vehicle. The electrical component, such as an IMS, includes a housing and has electrical connections that are accessible from the housing. A shield is mounted to the housing and electrically mates with the electrical connections. Advantageously, the shield has an electrical connector that mates with a unique electrical connector of a target vehicle in which the component is to be installed. The shield is removably and interchangeably mounted to the housing. As such, a wide variety of shields can be interchangeably mounted to the IMS to configure the latter to directly connect to a wide variety of unique electrical connectors of different vehicles.

In certain exemplary embodiments, the electrical component can be, e.g., an IMS relay switch or a solenoid. In further exemplary embodiments, the electrical connector of the shield comprises a port that plugs into a corresponding connector of the specific vehicle. This port may, e.g., include the electrical connections to the switch terminal of the magnetic switch, among other connections.

In another embodiment, the present invention provides a method of manufacturing a component of the type that is electrically connectable to an electrical system of a vehicle. In this method, a component with electrical connections (e.g., terminals) is provided. Also provided is an interchangeable shield that mates with the electrical connections of the component. The shield is configured with electrical connectors such as ports or plugs that are adapted for connection to specific connectors of a specific vehicle, e.g., a specific plug-type connector or wiring harness. Another aspect of this method contemplates providing several differently configured shields. Each shield can easily mate with the component, but each shield will have different electrical connectors adapted for connection to the different connectors of the target vehicles. In this manner, a component such as an IMS can be easily adapted to be connected to a multitude of different unique vehicle wiring systems, yet the component need not be redesigned or re-engineered for each particular application.

### BRIEF DESCRIPTION OF THE DRAWINGS

The above mentioned and other features of this invention, and the manner of attaining them, will become more apparent and the invention itself will be better understood by reference to the following description of embodiments of the invention taken in conjunction with the accompanying drawings, wherein:

FIG. 1 is a perspective view of a starter assembly for a vehicle, including a solenoid and IMS mounted thereto;

FIGS. 2 and 2A are perspective and plan views, respectively, of an IMS having a conventional shield that protect the electrical terminals;

FIGS. 3, 3A and 3B are perspective, plan and side views, respectively, of an IMS having an interchangeable shield in accordance with these teachings;

FIGS. 4A, 4B and 4C show the shield of FIG. 3 with the electrical connections illustrated in more detail;

FIGS. 5A-5C show different perspective views of the shield of FIG. 3; and

FIGS. 6A and 6B show an optional embodiment in which a terminal port is sealed with an epoxy or similar material.

Corresponding reference characters indicate corresponding parts throughout the several views. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION

The embodiments described below are not intended to be exhaustive or to limit the invention to the precise forms disclosed in the following detailed description. Rather, the embodiments are chosen and described so that others skilled in the art may appreciate and understand the principles and practices of these teachings.

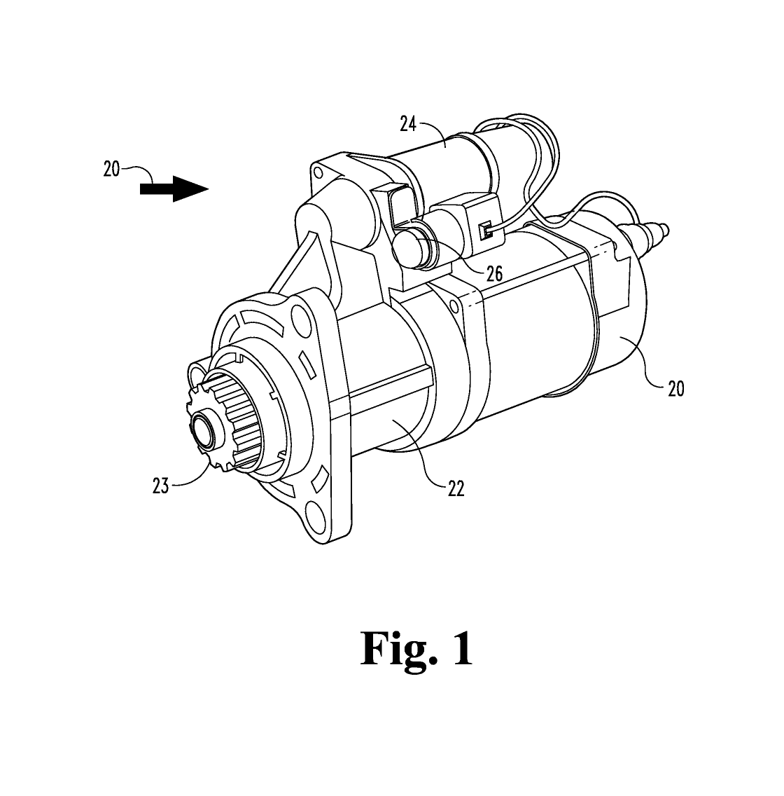

FIG. 1 shows a starter assembly 20 having a starter motor housing 22, pinion gear 23 and a solenoid 24. A shift lever (not shown) operatively connects the solenoid 24 to the drive assembly. The solenoid 24 includes a solenoid coil that is linked to a solenoid plunger within the solenoid housing, which in turn is linked to the pinion gear 23 though a shift lever that is concealed in FIG. 1. When the solenoid coil is energized, the solenoid plunger extends, thereby pivoting the shift lever. The shift lever urges the pinion gear into operative engagement with a flywheel provided in a vehicle engine. Starter assembly 20 also includes a relay, more particularly, an IMS switch, which allows the starter to receive the proper voltage during the cranking cycle and limits the effects of low system voltage. As shown in FIG. 1, IMS 26 is mounted and electrically connected to solenoid 24 and is wired to the system ignition switch.

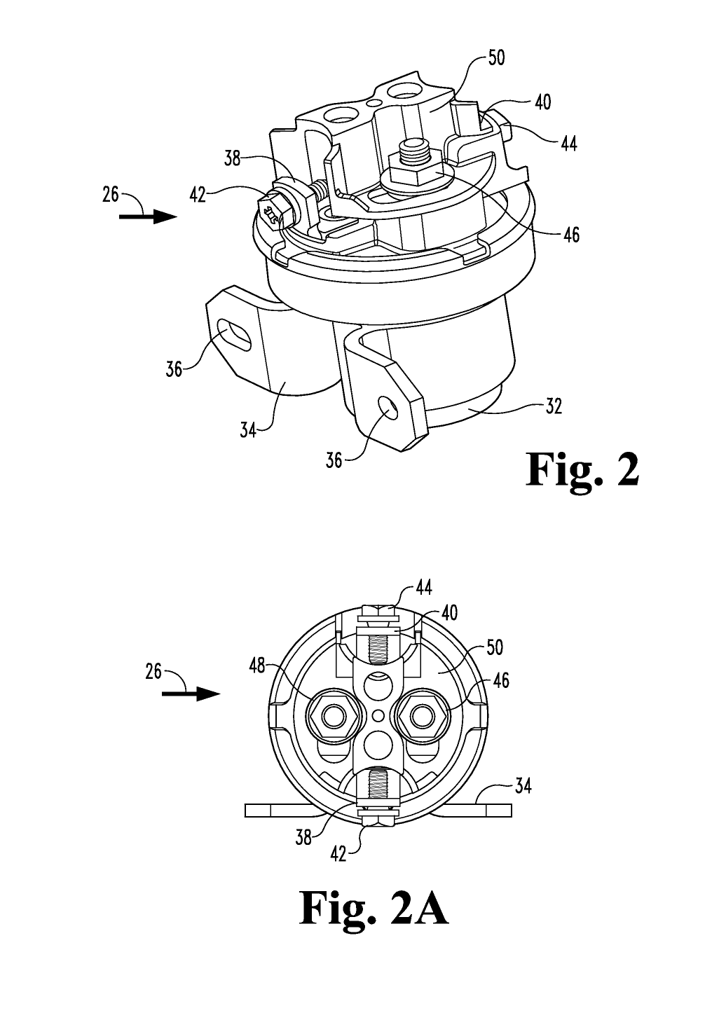

With reference to FIGS. 2 and 2A, IMS 26 includes a housing 32 which can be attached by means of bracket 34 to a solenoid. Holes 36 can be aligned with corresponding threaded bolt holes in the solenoid housing such that IMS 26 can be secured to the solenoid with machine screws, by way of non-limiting example. The particular location the IMS is mounted to the solenoid can vary and in some cases the IMS may be mounted directly to the starter housing.

As shown in FIGS. 2 and 2A, IMS 26 includes an ignition switch terminal 38 that is typically wired to the vehicle's ignition switch and a ground terminal 40 that is wired to an appropriate ground location. IMS 26 can, alternatively, be grounded directly to, e.g., mounting bracket 34, thereby obviating the need for a separate ground wire. In the illustrated embodiment, terminals 38 and 40 are provided with respective terminal screws 42 and 44, which allow wires to be connected and secured to the terminals. Similarly, terminals 46 and 48 are used to wire the IMS to the solenoid battery terminal (not shown) and solenoid switch terminal (not shown), respectively, so that, when the IMS is activated by, e.g., the operator turning the ignition switch, power is provided to the solenoid and starter. A shield 50 is provided at the top of IMS 26 to protect terminals 38, 40, 46 and 48 and prevent accidental shorting of these terminals. Shields such as shield 50 are commonly known in the art as “jump start protection” covers or simply a JSP.

In certain applications, the configuration of one or more of terminals 38, 40, 46 or 48 may be inconvenient for connecting to the vehicle in which IMS 26 is going to be used. For example, a particular vehicle in which IMS 26 could be installed might be configured, e.g., with a wiring harness having a plug-in male end that includes the connections for the ignition switch and ground of the IMS. In such event, connecting this single male plug to terminals 38 and 40 would undesirably require adaptors, which in turn would require additional connections, consume more space and perhaps confuse the installer who must make these connections. Similarly, another vehicle suitable for use with IMS 26 may have yet a different plug or wiring harness for the ignition switch, ground wires, or solenoid terminals that would also require additional connectors and adaptors to mate with such plug.

Indeed, there is a large variety of different vehicles and vehicle starter motors with which IMS 26 is compatible and a concomitant wide variety of plugs or wiring harnesses to which the IMS should be connectable. At the same time, it is highly desirable to provide easy “plug and play” connections so that the installation of IMS 26 can be done efficiently and without error by the user. This introduces the problem of having to make multiple different adaptations to IMS 26 to mate it with these multiple different wiring harnesses. It could require significant engineering resources, new component tooling, new process development, validation and significant time to implement even a single change to IMS 26 so that it could be adapted to a particular vehicle's electrical connections.

To address this problem, the inventors of the instant invention have invented a modular shield that can be interchanged with shield 50. This modular innovation provides a set of differently configured shields that can be interchangeably installed onto IMS 26 quickly and easily. Each particular shield of the set can be configured for the unique electrical ports or connectors of a particular target vehicle. In this manner, IMS 26 itself need not be redesigned for each different connection required for each unique application. This modular design reduces or eliminates engineering resources, new component tooling, process development, and validation of design concepts that would be required to provide separate covers, adaptors and the like to mate IMS 26 to a particular plug-in connector or wiring harness. Quite remarkably, the inventors have found this modular design to be cost-efficient and expedient as well as flexible.

That is, a wide variety of different connectors can be accommodated by simply interchanging a single part on IMS 26, and the interchange can be done quickly with only a few simply tools, as explained in more detail below.

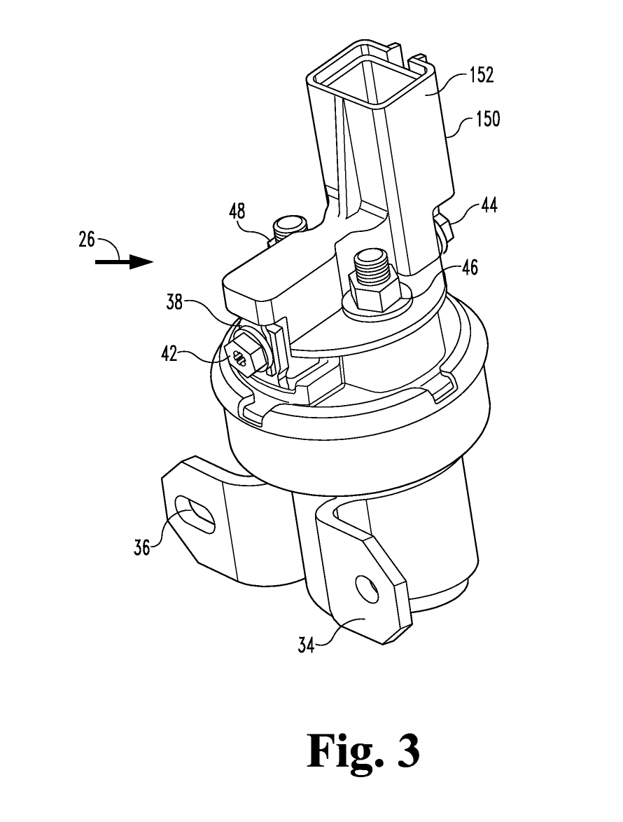

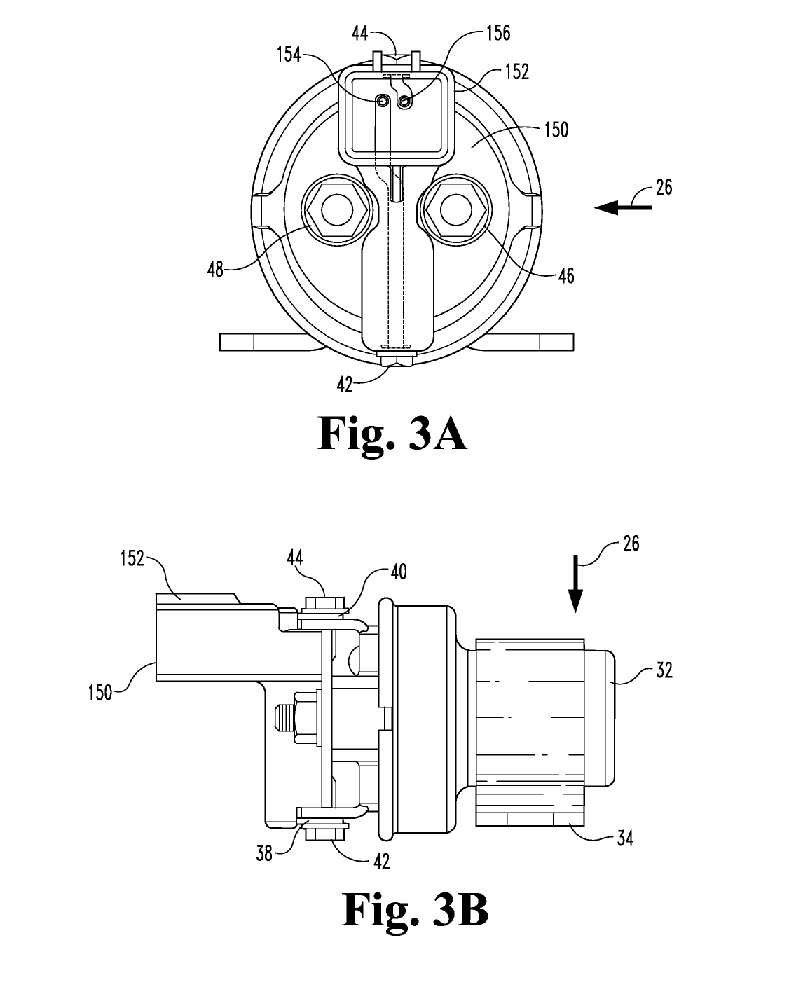

Turning then to FIGS. 3, 3A and 3B, IMS 26 is shown with one example of a modular shield 150 having a connector in the form of female port or socket 152 in which is disposed two terminal pins 154 and 156 (FIG. 3A), which electrically connect to terminals 38 and 40, respectively, as described in more detail below. Shield 150 is shaped and configured to (1) protect terminals 38, 40, 46 and 48, i.e., jump start protection; (2) provide a particularly configured port or plug to mate with a specific target connector for a particular application; and (3) provide electrical connections between the connector/adaptor, e.g., port 152, and one or more of terminals 38, 40, 46 and 48. The particular shape of the modular shield, then, is a design variable based upon the foregoing considerations. For a shield that requires a port for connections to all four terminals 38, 40, 46 and 48, the shield would be configured differently. One of skill in the art would thus readily appreciate that there are a wide variety of configurations in which shield 150 may be provided.

Shield 150 can be manufactured by conventional processes. For example, an overmolding application can be performed in which an overmold is injection molded around the pins 154 and 156 and associated electrical terminals. This injection can be done with a multishot process or by insert molding using, e.g., a nylon elastomer resin. One of skill in the art will appreciate that many different materials and processes can be employed to produce modular shield 150, depending upon the particular design and circumstances.

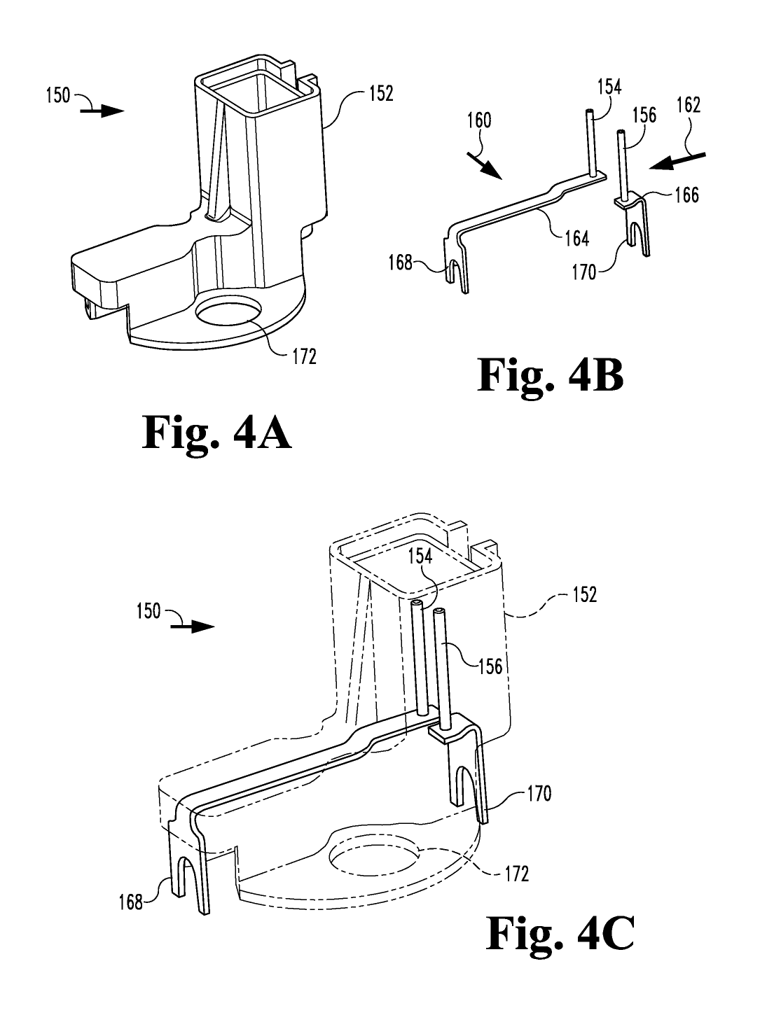

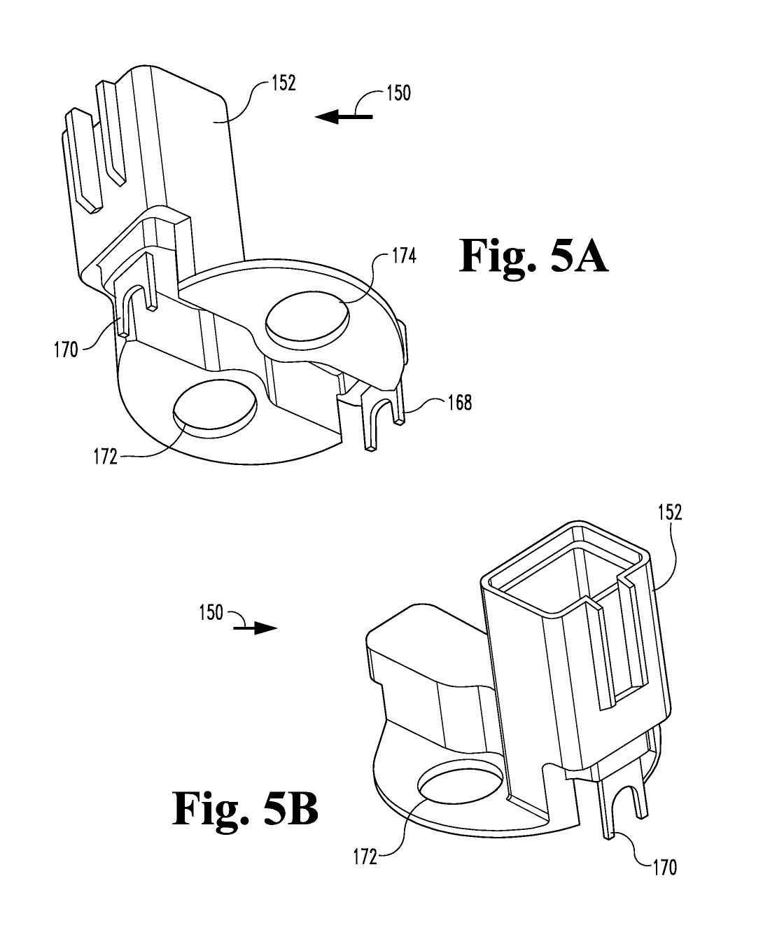

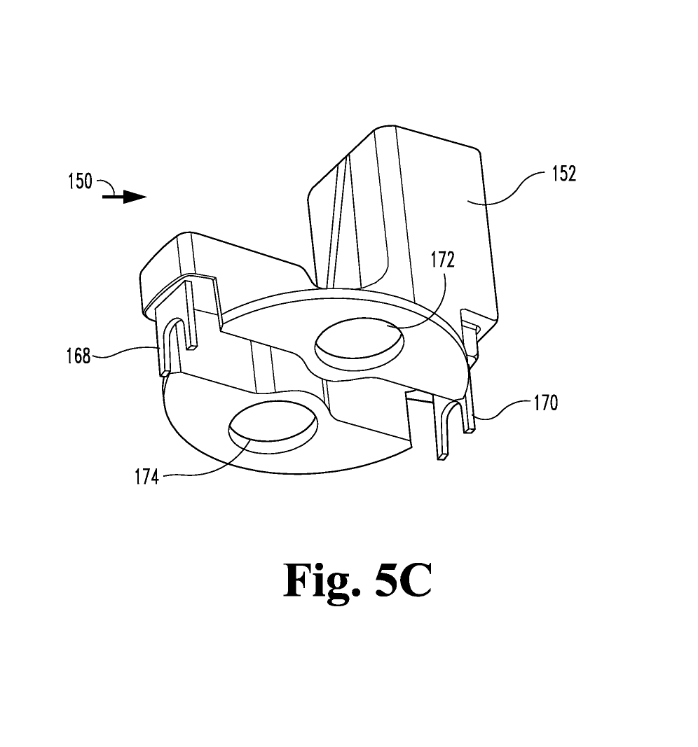

With reference to FIGS. 4A-4C, the different components of the exemplary shield 150 can be appreciated. As shown, the body of shield 150 is molded over connector assemblies 160 and 162. Connector assembly 160 includes pin 154, which, as noted elsewhere, connects to a female socket (not shown) provided in the male connector plug (not shown) for the particular application. Connector 160 includes a terminal portion 164 that extends through the shield as shown and terminates in spade-type connector 168, which is intended to fit over the cylindrical shank of terminal screw 42 (FIG. 3). Similarly, connector assembly 162 includes pin 156, which connects to another female socket (not shown) provided in the male connector plug (not shown) for the particular application. Connector 162 includes a terminal portion 166 also having a spade-type end 170 which is intended to fit over the cylindrical shank of terminal screw 44 (FIG. 3). Once part 150 is molded, the connector assemblies 160 and 162 are firmly fixed therein, such that the spade connections 168 and 170 assist with securing the shield 150 to the remainder of the IMS 26. Similarly, two holes 172 and 174 (also see FIG. 5) are provided in the body of shield 150 to allow the terminal screws for terminals 46 and 48 to pass therethrough. Once terminals 46 and 48 are connected and their associated nuts are tightened, this also secures the shield with respect to the body of IMS 26.

FIGS. 5A-5C show various perspective views of the illustrated embodiment of shield 150 before it is installed onto IMS 26.

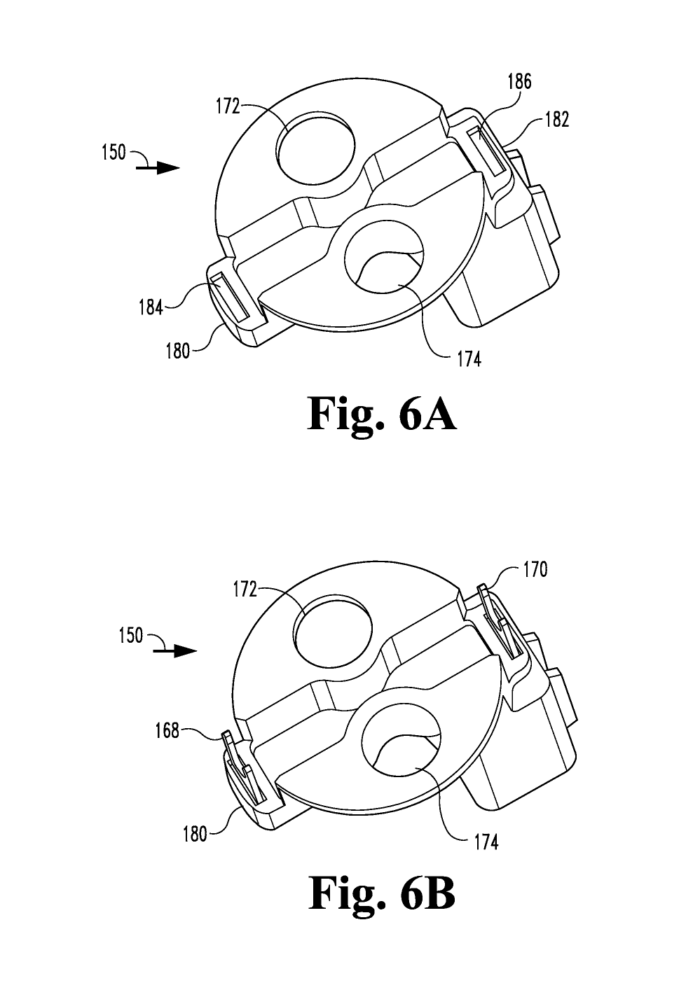

FIGS. 6A-6B depict an optional feature in which rectangular openings or pockets 180 and 182 are provided from which terminal leads 168 and 170 exit, respectively. These pockets can be filled with epoxy or other material to seal these areas from possible water ingression through openings 180 and 182.

While one specific example of shield 150 has been illustrated, one of skill in the art will readily appreciate that these teachings are not so limited. For example pins 154 and 156 could instead be provided in numerous other configurations, e.g., blades, posts, sockets, etc. Furthermore, as alluded above, the shape of port or socket 152 is a design variable, and port 152 will typically be configured to mate with a unique connector of the target vehicle, and only in a single orientation to ensure that the connection is correct. Still further, it should be understood that shield 150 could also be configured, additionally or alternatively, with plug-type ports or connectors for terminals 46 and 48, for example. This could be done by means of a single port such as port 152 configured with additional pin connections or by providing an additional port. One of skill in the art would appreciate the possibility of numerous other variations that are made possible by these teachings. In this manner, IMS 26 can be provided as a plug and play module that can be installed quickly and easily into a wide variety of differently configured applications while reducing the risk of installation error.

Furthermore, the innovative shield also provides advantages in terms of manufacturing, in that only the modular shield requires different connection configurations. The remainder of IMS can remain the same for all connections. Providing a series of interchangeable shields that can be quickly and easily switched at the factory before shipping is more efficient and economical than having to engineer individual IMS units for each specific application. In this connection, this invention also thus provides significant advantages in the context of retrofitting existing IMS switches and minimizing changes to existing designs. For example, a factory may have a large foreseeable future demand for IMS switches 26 that are compatible with the existing shield 50. Rather than needing to redesign IMS 26 for each new application as it arises, these teachings provide an innovative retrofitting solution in which the design of the IMS can remain the same, but the shield can be selected from one of several different configurations to provide a direct connection for the specific application. Still further, one of skill in the art would recognize that these teachings are not limited to applications such as, e.g., an IMS switch. These teachings could also be utilized for a shield for, e.g., a solenoid to connect the same to a specific port, plug or harness of a target vehicle. One of skill in the art would recognize the potential for these teachings to be used in yet other applications.

While this invention has been described with reference to exemplary embodiments, the present invention may be further modified within the spirit and scope of this disclosure. This application is therefore intended to cover any variations, uses, or adaptations of the invention using its general principles.

What is claimed is:

1. An electrical component for use with a vehicle, comprising:
a housing;
electrical connections accessible from the housing;
a shield mounted to the housing and electrically mating with the electrical connections, the shield having an electrical connector that mates with a corresponding electrical connector of a specific vehicle; and
the shield being removably and interchangeably mounted to the housing, whereby the shield may easily be configured to connect to multiple unique electrical connectors.

2. The electrical component of claim 1, wherein the electrical component comprises a solenoid.

3. The electrical component of claim 1, wherein the electrical component comprises a magnetic switch.

4. The electrical component of claim 3, wherein the electrical connector of the shield comprises a port that plugs into a corresponding connector of the specific vehicle.

5. The electrical component of claim 4, wherein the electrical connector of the shield comprises electrical connections to the switch terminal of the magnetic switch.

6. A modular system for connecting a magnetic switch to a starter system of a vehicle, comprising:
a magnetic switch; and
a plurality of shields that are interchangeably connectable to the magnetic switch, each shield being configured with a different connector adapted to directly connect to a respective specific plug or harness of a target vehicle.

7. The system of claim 6, wherein one of the shields of the plurality of shields comprises a port that plugs into a corresponding connector of the specific vehicle.

8. The system of claim 6, wherein each shield of the plurality of shields has the same connections to the magnetic switch.

9. A method of manufacturing a component of the type that is electrically connectable to an electrical system of a vehicle, the method comprising;
providing the component with electrical connections;
providing an interchangeable shield that mates with the electrical connections of the component, the shield having electrical connectors adapted for connection to specific connectors of a specific vehicle.

10. The method of claim 9, further comprising providing a plurality of differently configured shields, each shield having the same configuration for mating with the component and each shield having different electrical connectors adapted for connection to different connectors.

11. The method of claim 9, wherein the components comprise magnetic switches adapted to connect to a starter system of a vehicle.
